(19) United States
(12) Patent Application Publication
(10) Pub. No.: US 2011/0044781 A1
(43) Pub. Date: Feb. 24, 2011

(54) MILLING MACHINE DESIGNED FOR EASE OF TRANSPORT

(75) Inventors: Gregory Todd Jackson, Middleton, WI (US); Matthew McNear Doeppers, Fitchburg, WI (US); Eirc Peter Andersen, Lone Rock, WI (US)

Correspondence Address: TORMACH LLC;attn: Gregory Jackson, 204 MORAVIAN VALLEY ROAD, SUITE N, WAUNAKEE, WI, 53597, US

(73) Assignee: Tomach LLC, Waunakee, WI (US)

(21) Appl. No.: 12/546,011

(22) Filed: Aug. 24, 2009

(51) Int. Cl. B23C 9/00; B23Q 1/26

(52) U.S. Cl. 409/241

(57) ABSTRACT

An improved design and method is disclosed to disassemble a milling machine for transport and to reassemble it when transport is complete. The invention essentially comprises a hinge located at the bottom of the mill column to facilitate the disassembly and subsequent reassembly of the mill column from the mill base. The hinge protects the precise alignment surfaces at the bottom of the mill column and the top of the mill base from damage during both assembly and disassembly. In addition, it guides and stabilizes the column which makes it easier to remove and reattach the mill column to the mill base. By separating the milling machine into two components transportation is made easier and it becomes possible to install a milling in many locations that were previously inaccessible. The simplicity of the method will be advantageous for shops where space constraints make milling machine installation difficult.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The present invention relates generally to milling machines, and in particular to a method of configuring a milling machine for ease of disassembly, transport, and subsequent reassembly.

2. Description of the Prior Art

Milling machines are well known devices in the machine tool art. They are used extensively to perform a variety of machining operations including drilling and cutting. In milling machines a removable tool, typically vertically oriented, is secured in and projects downward from the lower end of a power driven spindle which is movable along one axis and mounted to a column. This tool is used to perform machining operations on a workpiece which is typically held on a horizontal table capable of movement along two or more different axes.

In order to maintain accuracy during machining the frame elements of the milling machine, in particular the base, column, and horizontal table, contain significant mass. This mass is used to provide the strength and stiffness which is needed to withstand the large forces that can develop during machining operations. The mass also serves to damp out vibrations which can develop during the operation of the milling machine. In addition to the strength required the massive column and horizontal table must be precisely aligned to the base in order to ensure the accuracy of the machining operations.

Due to the significant mass moving milling machines involves considerable difficulty and expense. Many locations, particularly those that require access by stairs, around tight corners, or through small doorways are not accessible to milling machines. Even in locations where access is possible it is often necessary to hire specialized riggers to load, transport, and install milling machines due to their significant mass. The cost of hiring these riggers can be a significant portion of the cost of the entire milling machine.

There exists a need, particularity in small and hobby shops, for a milling machine that is massive enough to provide accurate milling operation and yet easily moved and transported. Since this market is very cost sensitive any solution to this problem must be inexpensive.

Various aspects of this need have been recognized in the prior art. The prior art includes methods for disassembling a mill for ease of transport. U.S. Pat. No. 5,001,818 (Kramer) describes a milling machine with a separable platform. In the Kramer patent a hydraulic lock is used to fix the stationary base to a mill. U.S. Pat. No. 4,022,106 (Kile) discloses a portable machine tool which can be transported and mounted to a large work piece. Both of these methods require complex fastening means which are not feasible for machines intended for small shop and hobby use. U.S. Pat. No. 3,412,813 (Johnson) describes a core drill and stand which are separable for ease of transportation. The precision obtained by the method disclosed in Johnson, while acceptable for a core drill, is not sufficient for a milling machine.

Hinges and pivots for adjusting the alignment of machine tools to the workpiece are disclosed in U.S. Pat. No. 2,887,910 (Williamson) and U.S. Pat. No. 5,885,037 (Heintzeman). They allow the cutting tool to be located at various angular positions relative to the workpiece but, like Johnson, they reduce the accuracy of a milling machine. They also do not assist with the disassembly of the milling machine for transportation.

The use of pivoting mill tables and columns is also well known in the art. For example U.S. Pat. No. 5,662,441 (Wang) discloses a mill with a pivot for column rotation and U.S. Pat. No. 3,998,127 (Romeu) discloses a pivoting mill table. Neither Wang or Romeu provide for a way to assist with the separation of the mill column from the base.

The methods disclosed in the prior art for disassembly and transport of mill components either require complex and expensive fastening means which make their use on a milling machine designed for small shops and hobby use not feasible, or they do not provide the precision required by a high end milling machine. The methods disclosed in the prior art for pivoting and rotation of mill columns and tables do not facilitate disassembly and subsequent transportation.

### SUMMARY OF THE INVENTION

In view of the foregoing disadvantages inherent in the disassembly and reassembly of milling machines existing in the prior art the present invention provides an improved method to dissemble a milling machine for transport and to reassemble it when transportation is complete. The simplicity of the method will be advantageous for many small and hobby shops and the low cost will keep the milling machine in the required price range. The general purpose of the present invention, which will be described subsequently in greater detail, is to provide a new and improved way of disassembling and reassembling a milling machine which has all of the advantages of the prior art milling machines and none of the disadvantages.

To achieve this purpose the present invention essentially comprises a hinge located at the bottom of the column to facilitate the disassembly of the column from the base of the milling machine and its subsequent reassembly. The hinge protects the precise alignment surfaces at the bottom of the column and the top of the base from damage during both assembly and disassembly. In addition, it guides and stabilizes the column which makes it much easier to remove and reattach the column to the base. By separating the milling machine into two components transport is made much easier. Many more locations are made accessible, especially in small and hobby shops which often operate with tight space constraints and restricted access.

There has thus been broadly outlined the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining one embodiment of the invention in detail, it is to be understood that the invention is not limited in its application to the details of construction and to the arrangements of the components set forth in the following description and illustrated in the drawings. The invention is capable of other embodiments and of being practiced and carried out in various ways.

Also, it is to be understood that the phraseology and terminology employed herein are for the purpose of description and should not be regarded as limiting. As such, those skilled in the art will appreciate that the conception, upon which this disclosure is based, may readily be utilized as a basis for the design of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the US Patent and Trademark Office, the public generally, and especially scientists, engineers and practitioners in the art not familiar with patent or legal terms or phraseology to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a new and improved configuration of a milling machine to facilitate the disassembly and subsequent reassembly of the milling machine column from the machine base which has all the advantages of prior art milling machines and none of the disadvantages.

It is another object of the present invention to protect the precise alignment surfaces at the bottom of the column and the top of the base from damage during both disassembly and assembly.

It is a further object of the present invention to provide a way to support and guide the column during disassembly and reassembly from the base of the mill.

These, together with other objects of the invention, along with the various features of novelty which characterize the invention, are pointed out with particularity in the claims annexed to and forming a part of this disclosure. For a better understanding of the invention, its operating advantages, and specific objects attained by its uses, reference should be had to the accompanying drawings and descriptive material in which there is illustrated a preferred embodiment of the invention.

### BRIEF DESCRIPTION OF THE DRAWINGS

The invention will be better understood when consideration is given to the following detailed description of the preferred embodiment of the invention. Such description makes reference to the following drawings:

FIG. 1 is a perspective view of a milling machine as utilized in the present invention in the fully assembled position.

FIG. 1A is a magnified perspective view of FIG. 1 showing the hinge connecting the mill column to the mill base.

FIG. 2 is a perspective view showing the hinge pin and the cam on the hinge pin.

FIG. 3 is a side view of the milling machine in the fully assembled position.

FIG. 3A is a magnified side view of the milling machine in the fully assembled position.

FIG. 4 is a side view of the milling machine after the clearance between the column and base has been increased and a spacer has been inserted.

FIG. 4A is a magnified side view of the milling machine after the clearance between the column and base has been increased and a spacer has been inserted.

FIG. 5 is a perspective view of the milling machine showing the spacer.

FIG. 6 is a side view of the milling machine with the column rotated back and away from the base.

FIG. 7 is a perspective view of the milling machine with the column separated from the base.

### DETAILED DESCRIPTION OF THE PREFERRED EMBODIMENT

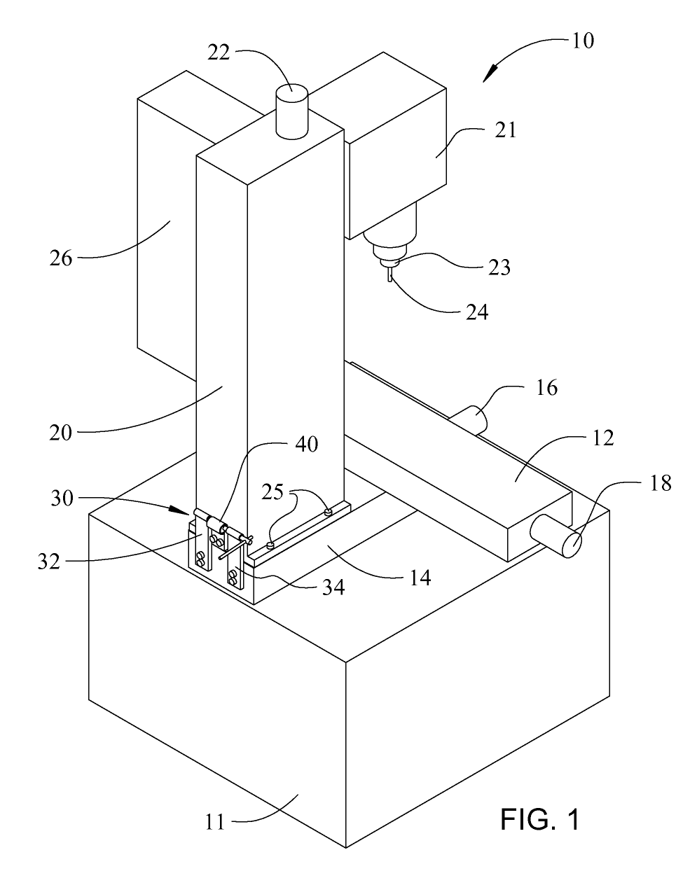

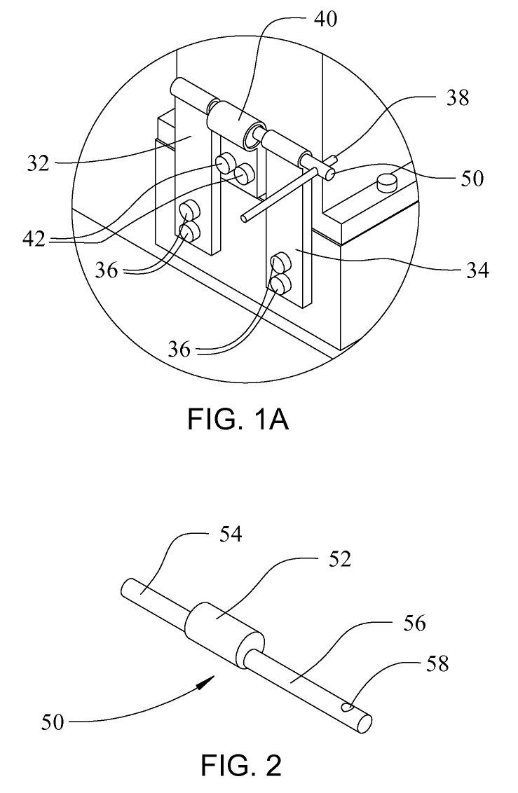

With reference now to the drawings, wherein like numerals designate like parts, a milling machine 10 is shown in FIG. 1. The milling machine 10 is supported on a stand 11. The mill table 12 is mounted on the mill base 14. The table 12 is capable of translation in one linear path by conventional driving means 16 and in a second linear path by conventional driving means 18. The mill column 20 is also mounted on the base 14. The column 20 supports spindle head 21 which is capable of translation along a vertical path by conventional driving means 22. A spindle 23 and driving means 16, 18 and 22 are typically operated under computer control. A cutting tool 24 is mounted in spindle 23 and is also operated under computer control. Control panel 26 contains the controls used to operate the milling machine.

To maintain accuracy during machining it is critical that table 12 and column 20 are precisely aligned to base 14. Column 20 is fastened to base 14 using conventional fastening means 25. The above construction and mode of operation is conventional and well-known to those skilled in the art and, for purposes of this invention, a more detailed description of a milling machine is unnecessary.

As shown in FIGS. 1 and 1A the present invention involves the use of a hinge 30 connected to the bottom of column 20 and to base 14. Left outer hinge plate 32 and right outer hinge plate 34 are fastened to base 14 using fastening means 36. Center hinge plate 40 is fastened to the bottom the column 20 using fastening means 42. A handle 38 is connected to hinge pin 50.

As shown in FIG. 2 hinge pin 50 has a larger diameter center cam section 52 and two small diameter end sections 54 and 56. Hinge pin 50 also has means to attach a handle, shown as hole 58.

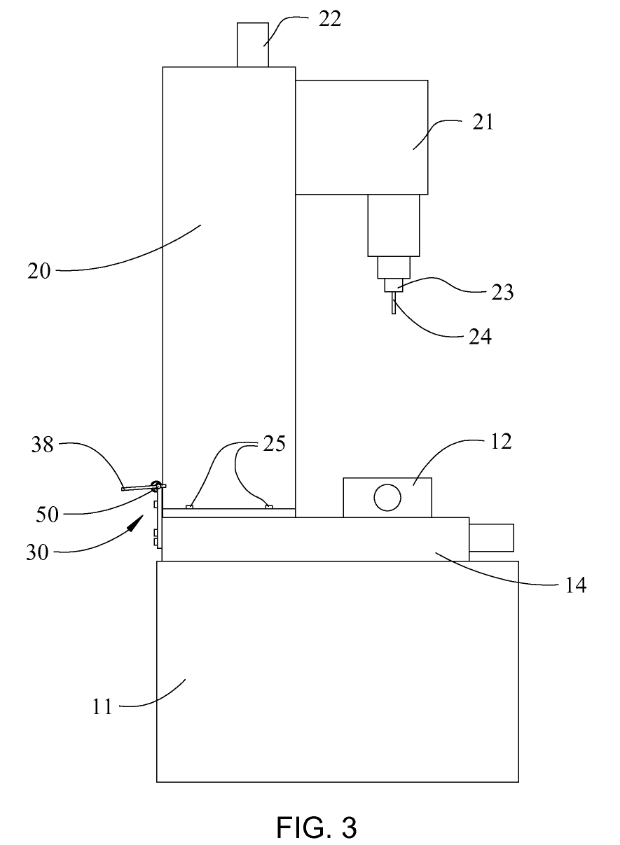

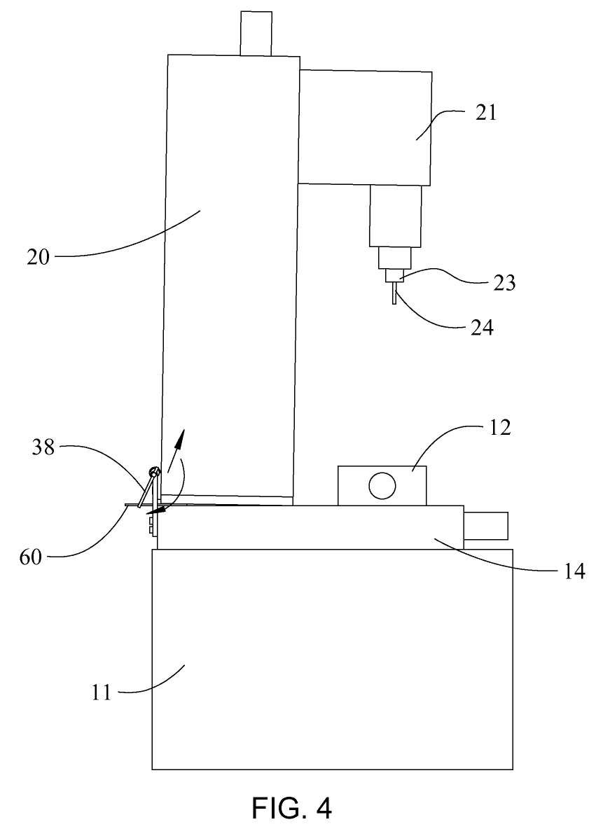

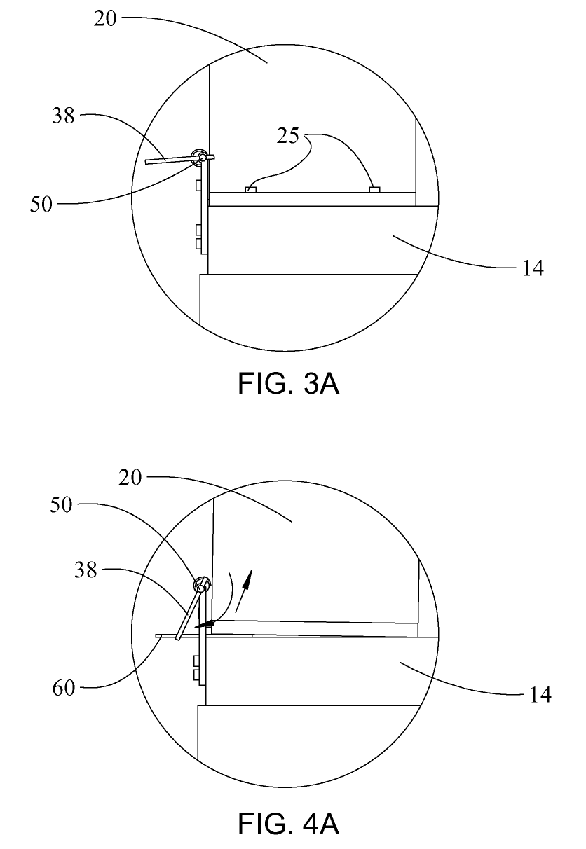

As shown in FIGS. 3 and 3A during normal operation the mill column 20 is securely mounted to the mill base 14 using fastening means 25. When it is necessary to separate the mill column 20 from the mill base 14 care must be taken to ensure that the bottom of mill column 20 and top of mill base 14 are not damaged. If these surfaces are damaged the accuracy of the milling machine will be reduced. Given that the mass of mill column 20 is significant and that control cabinet 26 contains sensitive electronics it is also advantageous to stabilize column 20 as it is separated from base 14.

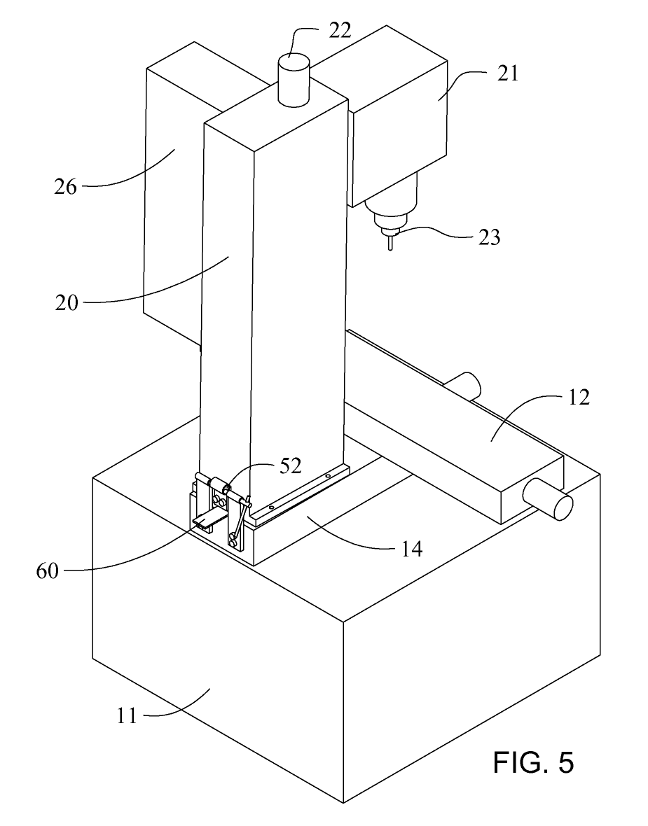

Prior to separation of column 20 from base 14 fastening means 25 are removed. Next handle 38 is rotated in a clockwise direction as shown by the arrow in FIGS. 4 and 4A. As handle 38 rotates pin 50 the large diameter center section 52 of pin 50 lifts column 20 up and to the right as shown in FIGS. 4 and 4A. This allows spacer 60 to be inserted between column 20 and base 14 as shown. FIG. 5 shows the position of spacer 60, pin center section 52, and column 20 after the spacer has been inserted. Spacer 60 serves to protect the precise alignment surfaces located at the bottom of column 20 and the top of base 14 from damage when column 20 is removed from base 14.

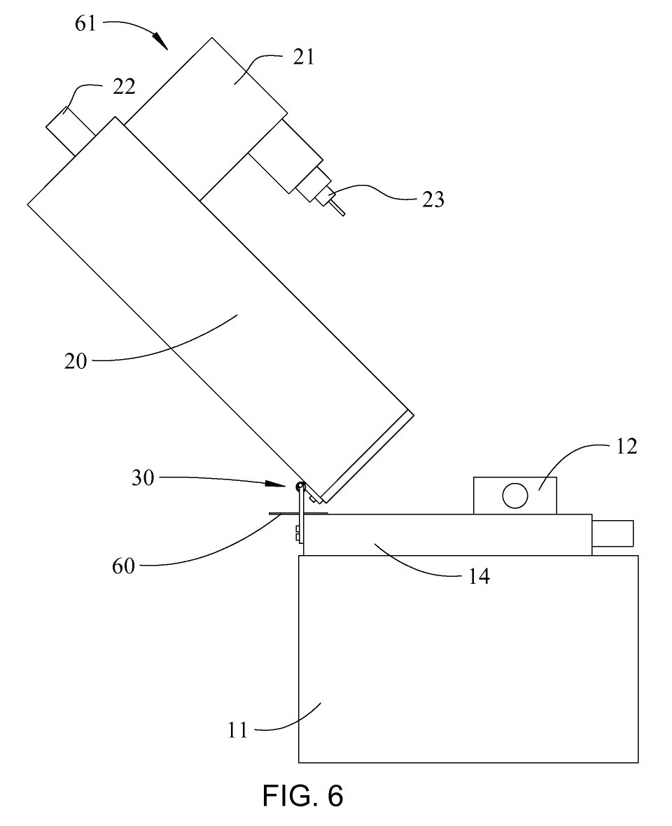

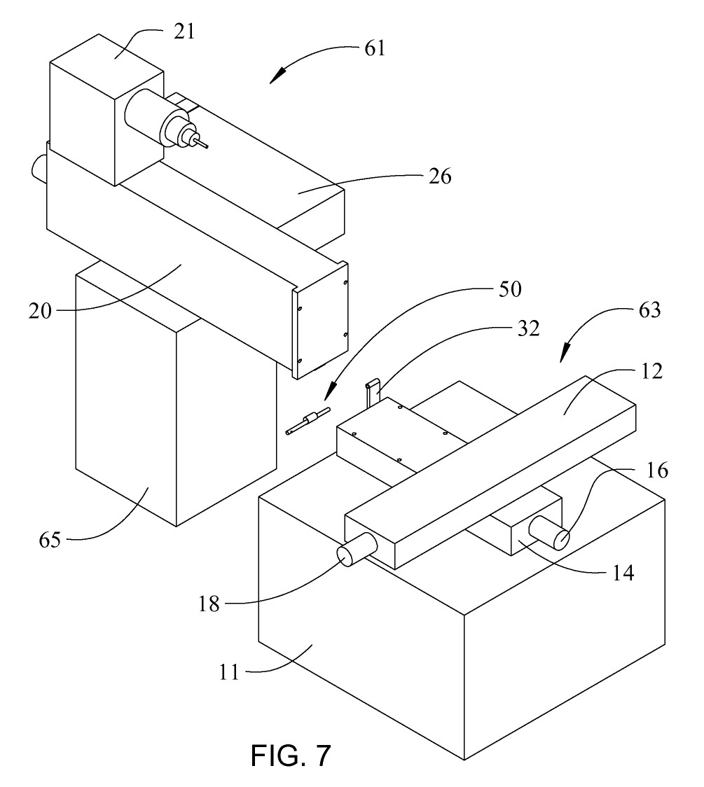

Column 20 is then rotated back and away from base 14 as shown in FIG. 6. Hinge 30 now serves to stabilize and guide the upper mill assembly 61, composed of column 20, spindle head 21, spindle 23, and driving means 22, as it is rotated free of base 14. Column 20 is rotated down and brought to rest on stand 65 as shown in FIG. 7. Then right outer hinge plate 34 is removed from base 14 by removing fastening means 36 on hinge plate 34. Pin 50 can then be removed from the hinge as shown in FIG. 7. The upper mill assembly 61 is now separated from base 14 and can be transported independently. The lower mill assembly 63, composed of table 12, base 14 and driving means 16 and 18, can also be transported separately.

After the upper mill assembly 61 and lower mill assembly 63 have been transported to a new location the above procedure is reversed to reassemble the milling machine. With the upper and lower assemblies properly aligned pin 50 is inserted through hinge plates 40 and 32. Hinge plate 34 is then fit over pin 50 and attached to base 14. Spacer 60 is inserted to protect the precise alignment surfaces and upper mill assembly 61 is rotated up to rest on base 14. Handle 38 is used to rotate pin 50 and raise column 20 and spacer 60 is removed. Handle 38 is rotated counterclockwise to gently lower column 20 onto base 14 and fastening means 25 are used to secure column 20 to base 14. The milling machine is now assembled and ready for use in the new location.

The key feature of the present invention is the use of hinge 30 and the cam section 52 on the center of hinge pin 50 to provide a way to quickly and easily separate the upper mill assembly 61 and lower mill assembly 63 for ease of transport.

It can readily be seen that the invention is characterized by simplicity and economy of construction. By incorporating the minor modifications of the present invention a milling machine can be configured for easy transport and installation in locations that would otherwise be inaccessible.

The advantages of the invention should now be readily apparent to those skilled in the art without the necessity for a more detailed description of the elements which are per se conventional, but which are utilized in the invention in unique combinations, making it possible to obtain results not previously possible.

With respect to the above description it is to be understood that the optimal dimensional relationships for the parts of the invention, to include variations in size, materials, shape, form, function and manner of operation, assembly, and use, are deemed readily apparent and obvious to one skilled in the art. All equivalent relationships to those illustrated in the drawings and described in the specification are intended to be encompassed by the present invention.

Therefore, the foregoing is to be considered as only illustrative of the principles of the invention. Since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A milling machining comprising:
a column supporting a power driven spindle which holds a cutting tool;
a table capable of movement along two or more different axes to which a work piece is mounted;
a base supporting said column and said table; and
a hinge located at the joint between said base and said column wherein one or more hinge mounting plates are fastened to said column and one or more hinge mounting plates are fastened to said base, said hinge providing a means of pivoting said column away from said base to facilitate the separation and subsequent reattachment of said column from said base.

2. The milling machining of claim 1 and adjusting means to adjust the position of said column relative to said base to provide clearance between said column and said base prior to disassembly of said column from said base.

3. The milling machining of claim 2 wherein said adjusting means comprises: One or more cam mechanisms located on the pin of said hinge; corresponding hinge plates configured such that rotation of said hinge pin adjusts the position of said column relative to said base to increase the clearance between said column and said base prior to disassembly of said column from said base.

4. In milling machining comprising:
a column supporting a power driven spindle which holds a cutting tool;
a table capable of movement along two or more different axes to which a work piece is mounted;
a base supporting said column and said table;
A method for separating said column from said base of said milling machine comprising the steps of;
providing a hinge between said column to said base;
providing an adjusting means capable of adjusting the position of said column relative to said base to provide clearance between said column and said base prior to disassembly of said column from said base;
removing fastening means connecting said column to said base; and
using said adjusting means to increase the clearance between said column and said base and then placing a spacer between said column and said base, rotating said column away from said base using said hinge to support and guide said column, and removing the pin of said hinge to allow said column and said base to be separated.
